(19) United States
(12) Patent Application Publication
(10) Pub. No.: US 2026/0199857 A1
(43) Pub. Date: Jul. 16, 2026

(54) GRANULATION AID COMPOSITIONS AND METHODS OF USE

(71) Applicant: Locus Solutions IPCO, LLC, Solon, OH (US)

(72) Inventors: Gabriela Knesel, Solon, OH (US); Ronney Silva, Solon, OH (US); Cathrine Monyake, Solon, OH (US)

(21) Appl. No.: 19/133,937

(22) PCT Filed: Dec. 1, 2023
(86) PCT No.: PCT/US2023/082019

§ 371 Date: May 29, 2025

Related U.S. Application Data
(60) Provisional application No. 63/429,371, filed on Dec. 1, 2022.

(51) Int. Cl. B01J 2/28; B01J 2/06

(52) U.S. Cl. CPC B01J 2/28; B01J 2/06

(57) ABSTRACT

The subject invention provides safe, environmentally-friendly compositions and efficient methods for granulation. More specifically, the subject invention provides compositions derived from microorganisms for granulation, which can be used for increasing the rate of granulation and/or the amount of aggregated particles.

### CROSS-REFERENCE TO RELATED APPLICATION

This application claims priority to U.S. Provisional Patent Application No. 63/429,371, filed Dec. 1, 2022, which is incorporated by reference herein in its entirety.

### BACKGROUND OF THE INVENTION

Various industrial and refining practices commonly employ the process of granulation. Most granulation processes involve treating particles with agents that increase the adhesive properties of the particles resulting in stable agglomerations of the particles. Depending on the type of granulation equipment and the granulation process being used, including, for example, dry granulation, wet granulation or direct compression, different chemical substances are used to aid the process.

In wet granulation, the components are blended in a suitable mixer followed by the addition of a binding agent and further mixing to achieve the desired consistency. After drying, the granulated compositions typically have a free flowing, sand-like texture. Granulation provides the required cohesiveness and compactability for compression into, for example, tablets of satisfactory hardness and friability.

Dry granulation is a method of controlled aggregation of particles that have been densified by, for example, passing the particles between two counter-rotating rolls. More specifically, powdered components are typically mixed before being densified to yield hard slugs, which are then ground and sieved before the addition of other ingredients and the final compression. Numerous problems exist in methods of dry granulation; particularly, many challenges exist in producing the desired kind of granules as well as managing the granulated material in the manufacturing process.

Direct compression can be the most economical process for producing aggregated particles. Direct compression uses only two principal steps: mixing the ingredients and compressing the ingredients. Therefore, the process may only be applied to materials that do not need to undergo additional processing (e.g., granulation) before the final compression. Therefore, direct compression is applicable to only a relatively small number of substances, as the ingredients of tablets or other products often need to be processed by a granulation technique to make them compressible and/or for improving their homogeneity and flow-ability.

The principal industry that employs granulation is the pharmaceutical industry. For the manufacturing of pharmaceutical tablets, granulation enables the consistent production of homogenous granules for further processing into tablets. Fertilizer production also employs granulation in the processing of raw materials into fertilizer granules. However, many binders or binding agents used in the granulation process are synthetic compounds (e.g., polysorbates, povidone, polyvinylpyrrolidone (PVP) and polyethylene glycol (PEG)), which may present issues of toxicity or biocompatibility.

Therefore, novel, improved granulation aid compositions and methods are needed.

### BRIEF SUMMARY OF THE INVENTION

The subject invention relates generally to granulation aid compositions and methods of using these compositions. More specifically, the subject invention provides environmentally-friendly granulation aid compositions and methods for granulation, such as, for example, during the processing of mined ores, elements, and minerals or during the manufacturing of fertilizers, pesticides, pharmaceuticals, cosmetics, food products, and dietary supplements. In certain embodiments, existing methods can incorporate the subject compositions and methods.

Advantageously, the compositions and methods of the subject invention increase the efficiency of granulation and can decrease the chemical usage, including synthetic binder usage, required for granulation. Accordingly, the subject invention can be useful for reducing the time needed for mining or production of various products, including, for example, pharmaceuticals or fertilizers.

In certain embodiments, the subject invention provides compositions comprising components that are derived from microorganisms. In certain embodiments, the composition comprises a microbial biosurfactant. In certain embodiments, the composition comprises one or more biosurfactants, and, optionally, other compounds, such as, for example, chemical surfactants, polymers, water, binders, solvents, or any combination thereof.

In certain embodiments, the biosurfactant of the composition is utilized in crude form. The crude form can comprise, in addition to the biosurfactant, fermentation broth in which a biosurfactant-producing microorganism was cultivated, residual microbial cell matter or live or inactive microbial cells, residual nutrients, and/or other microbial growth by-products.

In some embodiments, the biosurfactant is utilized after being extracted from a fermentation broth and, optionally, purified.

The biosurfactant according to the subject invention can be a glycolipid (e.g., sophorolipids, rhamnolipids, cellobiose lipids, mannosylerythritol lipids and trehalose lipids), lipopeptide (e.g., surfactin, iturin, fengycin, arthrofactin, and lichenysin), flavolipid, phospholipid (e.g., cardiolipins), fatty acid ester compound, fatty acid ether compound, and/or high molecular weight polymers such as lipoproteins, lipopolysaccharide-protein complexes, and polysaccharide-protein-fatty acid complexes.

In certain specific embodiments, the biosurfactant is a sophorolipid (SLP), including linear SLP, lactonic SLP, acetylated SLP, de-acetylated SLP, salt-form SLP, esterified SLP derivatives, amino acid-SLP conjugates, and other SLP derivatives or isomers that exist in nature and/or are produced synthetically. In preferred embodiments, the SLP is a linear SLP or a derivatized linear SLP.

In certain embodiments, the subject invention provides a method for granulation, wherein the method comprises the following step: contacting a granulation aid composition according to the subject invention to a mineral, ore, element, fertilizer, pesticide, pharmaceutical, cosmetic, food product, dietary supplement or other material used to synthesize a fertilizer, pesticide, pharmaceutical, cosmetic, food product, or dietary supplement.

In certain embodiments, the granulation composition according to the subject invention is effective due to enhancing and/or increasing the rate of agglomeration or total amount of the agglomerated particles from a liquid containing a colloidal suspension of said particles or the agglomeration of dry particles. In some embodiments, the method enhances the aggregation of particles or increases the rate of granulation and/or the amount of aggregated particles in a distinct time period. In certain embodiments, the resulting aggregated particles can be less than about 100 cm, about 50 cm, about 30 cm, about 10 cm, about 1 cm, about 1 mm, about 500 μm, about 100 μm, about 10 μm, about 1 μm, about 100 nm, about 10 nm, or about 1 nm in diameter.

In some embodiments, the method comprises contacting a granulation aid composition comprising a biosurfactant and, optionally, other components, such as, for example, chemical surfactants, polymers, water, binders, solvents, or any combination thereof to a mineral, ore, element, or other material used to create a fertilizer, pesticide, pharmaceutical, cosmetic, food product, or dietary supplement. The mineral, ore, element, or other material used to create a fertilizer, pesticide, pharmaceutical, cosmetic, food product, or dietary supplement can be a liquid or solid. In certain embodiments, the granulation aid composition can be applied to the mineral, ore, element, or other material used to create a fertilizer, pesticide, pharmaceutical, cosmetic, food product, or dietary supplement for a period of time and/or until a distinct volume of the composition has been applied. The step can be repeated as many times as necessary to achieve a desired amount of aggregated particles or rate of granulation of the mineral, ore, element, or other material used to create a fertilizer, pesticide, pharmaceutical, cosmetic, food product, or dietary supplement.

In certain embodiments, the granulation aid composition according to the subject invention is effective due to increasing the wettability and/or increasing aggregation of particles. For example, in some embodiments, a sophorolipid will form a micelle containing and/or linking the particles, wherein the micelle is less than 500 μm, less than 100 μm, less than 10 sm, less than 1 μm, less than 100 nm, less than 50 nm, less than 25 nm, less than 15 nm or less than 10 nm in size. The small size and amphiphilic properties of the micelle allow for enhanced penetration into the particles, allowing for enhanced wettability or aggregation of particles.

In certain embodiments, the methods of the subject invention result in at least a 25% increase in rate of granulation of solids, preferably at least a 50% increase, after one treatment. In certain embodiments, the mineral, ore, element, or other material used to create a fertilizer, pesticide, pharmaceutical, cosmetic, food product, or dietary supplement can be treated multiple times to further increase the amount of aggregated particles or rate of granulation.

Advantageously, in certain embodiments, the granulation aid composition according to the subject invention can be effective and efficient at creating an aggregated particle. Furthermore, the methods of the subject invention do not require complicated equipment or high energy consumption, and production of the composition can be performed on site, for example, at a mine or industrial production facility.

### DETAILED DESCRIPTION

The subject invention relates generally to the granulation of particles. More specifically, the subject invention provides environmentally-friendly compositions and methods for granulation of dry, solid particles or particles contained within liquids derived from a mined ore, element, or mineral or other material used to create, for example, a fertilizer, pesticide, pharmaceutical, cosmetic, food product, or dietary supplement. Accordingly, the subject invention is useful for improving the efficiency and efficacy of methods of granulation. Advantageously, the compositions and methods of the subject invention permit an increase in the granulation rate of particles using safe, environmentally-friendly compositions.

### Selected Definitions

As used herein, “applying” a composition or product refers to contacting it with a target or site such that the composition or product can have an effect on that target or site. The effect can be due to, for example, microbial growth and/or the action of a biosurfactant or other microbial growth by-product.

As used herein, a “biofilm” is a complex aggregate of microorganisms, such as bacteria, yeast, or fungi, wherein the cells adhere to each other and/or to a surface using an extracellular matrix. The cells in biofilms are physiologically distinct from planktonic cells of the same organism, which are single cells that can float or swim in liquid medium.

As used herein, an “isolated” or “purified” nucleic acid molecule, polynucleotide, polypeptide, protein or organic compound such as a small molecule (e.g., those described below), is substantially free of other compounds, such as cellular material, with which it is associated in nature. A purified or isolated polynucleotide (ribonucleic acid (RNA) or deoxyribonucleic acid (DNA)) is free of the genes or sequences that flank it in its naturally-occurring state. A purified or isolated polypeptide is free of the amino acids or sequences that flank it in its naturally-occurring state. An isolated microbial strain means that the strain is removed from the environment in which it exists in nature. Thus, the isolated strain may exist as, for example, a biologically pure culture, or as spores (or other forms of the strain) in association with a carrier.

In certain embodiments, purified compounds are at least 60% by weight the compound of interest. Preferably, the preparation is at least 75%, more preferably at least 90%, and most preferably at least 98%, by weight the compound of interest. For example, a purified compound is one that is at least 80%, 85%, 90%, 91%, 92%, 93%, 94%, 95%, 98%, 99%, or 100% (w/w) of the desired compound by weight. Purity is measured by any appropriate standard method, for example, by column chromatography, thin layer chromatography, or high-performance liquid chromatography (HPLC) analysis.

A “metabolite” refers to any substance produced by metabolism or a substance necessary for taking part in a particular metabolic process. A metabolite can be an organic compound that is a starting material, an intermediate in, or an end product of metabolism. Examples of metabolites include, but are not limited to, enzymes, acids, solvents, alcohols, proteins, vitamins, minerals, microelements, amino acids, biopolymers and biosurfactants.

Ranges provided herein are understood to be shorthand for all of the values within the range. For example, a range of 1 to 20 is understood to include any number, combination of numbers, or sub-range from the group consisting 1, 2, 3, 4, 5, 6, 7, 8, 9, 10, 11, 12, 13, 14, 15, 16, 17, 18, 19 and 20, as well as all intervening decimal values between the aforementioned integers such as, for example, 1.1, 1.2, 1.3, 1.4, 1.5, 1.6, 1.7, 1.8, and 1.9. With respect to sub-ranges, “nested sub-ranges” that extend from either end point of the range are specifically contemplated. For example, a nested sub-range of an exemplary range of 1 to 50 may comprise 1 to 10, 1 to 20, 1 to 30, and 1 to 40 in one direction, or 50 to 40, 50 to 30, 50 to 20, and 50 to 10 in the other direction.

As used herein a “reduction” or “decrease” means a negative alteration, and an “increase” means a positive alteration, wherein the negative or positive alteration is at least 0.001%, 0.01%, 0.1%, 0.5%, 1%, 5%, 10%, 15%, 20%, 25%, 30%, 35%, 40%, 45%, 50%, 55%, 60%, 65%, 70%, 75%, 80%, 85%, 90%, 95% or 100%.

As used herein, “surfactant” means a compound that lowers the surface tension (or interfacial tension) between two liquids or between a liquid and a solid. Surfactants act as, e.g., detergents, wetting agents, emulsifiers, foaming agents, and/or dispersants. A “biosurfactant” is a surface-active substance produced by a living cell and/or using naturally-derived substrates.

Biosurfactants are a structurally diverse group of surface-active substances consisting of two parts: a polar (hydrophilic) moiety and non-polar (hydrophobic) group. Due to their amphiphilic structure, biosurfactants can, for example, increase the surface area of hydrophobic water-insoluble substances, increase the water bioavailability of such substances, and change the properties of bacterial cell surfaces. Biosurfactants can also reduce the interfacial tension between water and oil and, therefore, lower the hydrostatic pressure required to move entrapped liquid to overcome the capillary effect. Biosurfactants accumulate at interfaces, thus reducing interfacial tension and leading to the formation of aggregated micellar structures in solution. The formation of micelles provides a physical mechanism to mobilize, for example, oil in a moving aqueous phase.

The ability of biosurfactants to reduce the surface tension also permits their use as antibacterial, antifungal, and hemolytic agents to, for example, control pests and/or microbial growth.

Typically, the hydrophilic group of a biosurfactant is a sugar (e.g., a mono-, di-, or polysaccharide) or a peptide, while the hydrophobic group is typically a fatty acid. Thus, there are countless potential variations of biosurfactant molecules based on, for example, type of sugar, number of sugars, size of peptides, which amino acids are present in the peptides, fatty acid length, saturation of fatty acids, additional acetylation, additional functional groups, esterification, polarity and charge of the molecule.

These variations lead to a group of molecules comprising a wide variety of classes, including, for example, glycolipids (e.g., sophorolipids, rhamnolipids, cellobiose lipids, mannosylerythritol lipids and trehalose lipids), lipopeptides (e.g., surfactin, iturin, fengycin, arthrofactin and lichenysin), flavolipids, phospholipids (e.g., cardiolipins), fatty acid ester compounds, and high molecular weight polymers such as lipoproteins, lipopolysaccharide-protein complexes, and polysaccharide-protein-fatty acid complexes. Each type of biosurfactant within each class can further comprise subtypes having further modified structures.

Like chemical surfactants, each biosurfactant molecule has its own HLB value depending on its structure; however, unlike production of chemical surfactants, which results in a single molecule with a single HLB value or range, one cycle of biosurfactant production typically results in a mixture of biosurfactant molecules (e.g., subtypes and isomers thereof).

The phrases “biosurfactant” and “biosurfactant molecule” include all forms, analogs, orthologs, isomers, and natural and/or anthropogenic modifications of any biosurfactant class (e.g., glycolipid) and/or subtype thereof (e.g., sophorolipid).

As used herein, the term “sophorolipid,” “sophorolipid molecule,” “SLP” or “SLP molecule” includes all forms, and isomers thereof, of SLP molecules, including, for example, acidic (linear) SLP (ASL) and lactonic SLP (LSL). Further included are mono-acetylated SLP, di-acetylated SLP, esterified SLP, SLP with varying hydrophobic chain lengths, cationic and/or anionic SLP with fatty acid-amino acid complexes attached, esterified SLP, SLP-metal complexes, SLP-salt derivatives (e.g., a sodium salt of a linear SLP), and other, including those that are and/or are not described within in this disclosure.

In certain embodiments, the glycolipid biosurfactant is a sophorolipid (SLP). Sophorolipids are glycolipid biosurfactants produced by, for example, various yeasts of the Starmerella clade when cultivated in the presence of a hydrocarbon-based source of one or more fatty acids. SLP typically consist of a disaccharide sophorose linked to long chain hydroxy fatty acids. They can comprise a partially acetylated 2-O-β-D-glucopyranosyl-D-glucopyranose unit attached β-glycosidically to 17-L-hydroxyoctadecanoic or 17-L-hydroxy-Δ9-octadecenoic acid. The hydroxy fatty acid is generally 16 or 18 carbon atoms, and may contain one or more unsaturated bonds. Furthermore, the sophorose residue can be acetylated on the 6- and/or 6′-position(s). The fatty acid carboxyl group can be free (acidic or linear form (General Formula 2)) or internally esterified at the 4″-position (lactonic form (General Formula 1)). S. bombicola produces a specific enzyme, called S. bombicola lactone esterase, which catalyzes the esterification of linear SLP to produce lactonic SLP.

In preferred embodiments, the SLP according to the subject invention are represented by General Formula (1) and/or General Formula (2), and include 30 or more structural homologs:

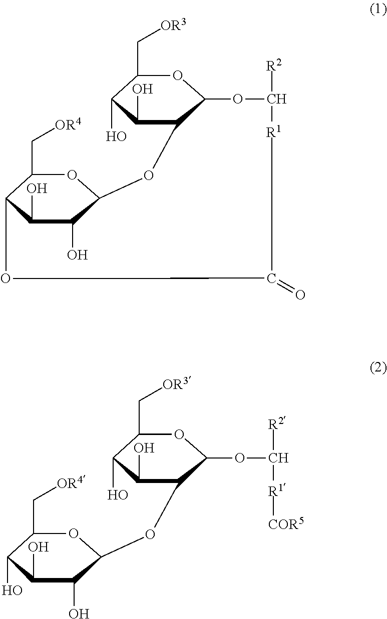

where R¹ and R^{1′} independently represent saturated hydrocarbon chains or single or multiple, in particular single, unsaturated hydrocarbon chains having 8 to 20, in particular 12 to 18 carbon atoms, more preferably 14 to 18 carbon atoms, which can be linear or branched and can comprise one or more hydroxy groups, R² and R^{2′} independently represent a hydrogen atom or a saturated alkyl functional group or a single or multiple, in particular single, unsaturated alkyl functional group having 1 to 9 carbon atoms, more preferably 1 to 4 carbon atoms, which can be linear or branched and can comprise one or more hydroxy groups, and R³, R^{3′}, R⁴ and R^{4′} independently represent a hydrogen atom or —COCH₃.

The composition utilized according to the subject methods can comprises more than one form of SLP, including linear SLP and lactonic SLP. The SLP can be non-acetylated, mono-acetylated and/or di-acetylated SLP.

In certain specific embodiments, the composition comprises SLP according to General Formula (1) (linear SLP) wherein R¹ and/or R² are an acetyl group, and wherein R³ is derived from a stearic, oleic and/or linoleic fatty acid.

SLP are typically produced by yeasts, such as Starmerella spp. yeasts and/or Candida spp. yeasts, e.g., Starmerella (Candida) bombicola, Candida apicola, Candida batistae, Candida floricola, Candida riodocensis, Candida stellate and/or Candida kuoi. SLP have environmental compatibility, high biodegradability, low toxicity, high selectivity and specific activity in a broad range of temperature, pH and salinity conditions. Additionally, in some embodiments, SLP can be advantageous due to their small micelle size, which can help facilitate the movement of the micelle, and compounds enclosed therein, through nanoscale pores and spaces. In certain embodiments, the micelle size of a SLP is less than 100 nm, less than 50 nm, less than 20 nm, less than 15 nm, less than 10 nm, or less than 5 nm.

In certain embodiments, the glycolipid is a rhamnolipid. Rhamnolipids comprise a glycosyl head group (i.e., a rhamnose) moiety, and a 3-(hydroxyalkanoyloxy)alkanoic acid (HAA) fatty acid tail, such as, e.g., 3-hydroxydecanoic acid. Two main subtypes of rhamnolipids exist, mono- and di-rhamnolipids, which comprise one or two rhamnose moieties, respectively. The HAA moiety can vary in length and degree of branching, depending on, for example, the growth medium and the environmental conditions. The highest accumulation of rhamnolipids (RLP) has been shown by submerged cultivation of Pseudomonas spp., such as P. aeruginosa.

Rhamnolipids according to the subject invention can have the following structure, according to General Formula (3):

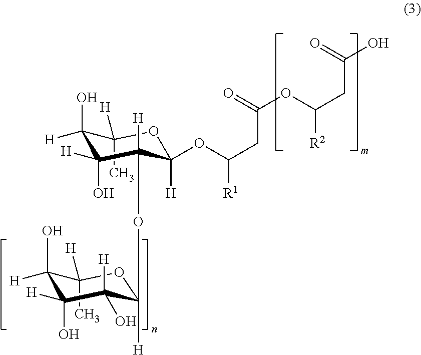

wherein m is 2, 1 or 0,
n is 1 or 0,
R¹ and R² are, independently of one another, the same or a different organic functional group having 2 to 24, preferably 5 to 13 carbon atoms, in particular a substituted or unsubstituted, branched or unbranched alkyl functional group, which can also be unsaturated,
wherein the alkyl functional group is a linear saturated alkyl functional group having 8 to 12 carbon atoms, or is a nonyl or a decyl functional group or a mixture thereof.

Salts of these compounds are also included according to the invention. In the present invention, the term “di-rhamnolipid” is understood to mean compounds of the above formula or the salts thereof in which n is 1. Accordingly, “mono-rhamnolipid” is understood in the present invention to mean compounds of the general formula or the salts thereof in which n is 0. In certain specific embodiments, the composition comprises a mixture of mono- and di-rhamnolipids. As used herein, “granulation” refers to the process of forming granules by aggregating particles. Methods of granulation include the use of an impeller, screw, or compressed air in which the particles are agitated. The methods may also employ rollers (rotating cylinders) for compressing the particles. For example, the rollers may be two counter-rotating rollers, through which the particles are passed and compressed.

As used herein, “ore” refers to a naturally occurring solid material from which a valuable substance, mineral and/or metal can be profitably extracted. Ores are often mined from ore deposits, which comprise ore minerals containing the valuable substance. “Gangue” minerals are minerals that occur in the deposit but do not contain the valuable substance. Examples of ore deposits include hydrothermal deposits, magmatic deposits, laterite deposits, volcanogenic deposits, metamorphically reworked deposits, carbonatite-alkaline igneous related deposits, placer ore deposits, residual ore deposits, sedimentary deposits, sedimentary hydrothermal deposits and astrobleme-related deposits. Ores, as defined herein, however, can also include ore concentrates or tailings, gold, or even other sources of metal or valuable minerals.

As used herein, the term “particles” includes mined ores, elements, compounds, minerals, or other material (e.g., gold, silver, mine, lead-zinc, tungsten, zinc, coal, calcite, limestone, aragonite, seashells, marl, limonite, clay, shale, sand, alumina, taconite, zircon, quartz and bauxite).

The transitional term “comprising,” which is synonymous with “including,” or “containing,” is inclusive or open-ended and does not exclude additional, unrecited elements or method steps. By contrast, the transitional phrase “consisting of” excludes any element, step, or ingredient not specified in the claim. The transitional phrase “consisting essentially of” limits the scope of a claim to the specified materials or steps “and those that do not materially affect the basic and novel characteristic(s)” of the claimed invention. Use of the term “comprising” contemplates other embodiments that “consist” or “consist essentially of” the recited component(s).

Unless specifically stated or obvious from context, as used herein, the term “or” is understood to be inclusive. Unless specifically stated or obvious from context, as used herein, the terms “a,” “and” and “the” are understood to be singular or plural.

Unless specifically stated or obvious from context, as used herein, the term “about” is understood as within a range of normal tolerance in the art, for example within 2 standard deviations of the mean. About can be understood as within 10%, 9%, 8%, 7%, 6%, 5%, 4%, 3%, 2%, 1%, 0.5%, 0.1%, 0.05%, or 0.01% of the stated value. Unless otherwise clear from context, all numerical values provided herein are modified by the term about.

The recitation of a listing of chemical groups in any definition of a variable herein includes definitions of that variable as any single group or combination of listed groups. The recitation of an embodiment for a variable or aspect herein includes that embodiment as any single embodiment or in combination with any other embodiments or portions thereof.

All references cited herein are hereby incorporated by reference in their entirety.

### Granulation Aid Compositions

In certain embodiments, the subject invention provides compositions comprising components that are derived from microorganisms. In certain embodiments, the composition comprises a microbial biosurfactant. In certain embodiments, the composition comprises one or more biosurfactants, and, optionally, other compounds, such as, for example, water, chemical surfactants, polymers, binders, solvents, or any combination thereof.

In certain embodiments, the chemical surfactant of the granulation aid composition is an anionic surfactant, a nonionic surfactant, detergent, wetting agent, emulsifier, foaming agent, and/or dispersant.

In certain embodiments, the binder is a naturally occurring binder including, for example, a starch (e.g., potato (granular) starch, sodium octenyl succinate starches, hydroxypropyl pea starch, pregelatinized starch), solidum alginate, acacia, alginic acid, cellulose, and gelatin; a synthetic binder, including, for example, polyvinyl pyrrolidone (PVP), methylcellulose, ethyl cellulose, hydroxy propyl methyl cellulose (HPMC), hydroxy propyl cellulose, sodium carboxy methyl cellulose, polyvinyl alcohols, polymethacrylates, sodium carboxy methyl cellulose, polyethylene glycol (PEG); or a saccharide, including, for example, disaccharides (e.g., lactose and sucrose), polysaccharides and their derivatives (e.g., starches, cellulose or modified cellulose MCC and cellulose ethers such as hydroxypropyl cellulose (HPC); or sugar derivatives (e.g., sorbitol, xylitol, and mannitol).

In certain embodiments, the solvent is water, alcohol, such as, for example, ethanol or isopropanol, or a combination thereof.

In certain embodiments, the granulation aid composition comprises a microbe-based product comprising a biosurfactant utilized in crude form. The crude form can comprise, in addition to the biosurfactant, fermentation broth in which a biosurfactant-producing microorganism was cultivated, residual microbial cell matter or live or inactive microbial cells, residual nutrients, and/or other microbial growth by-products. The product may be, for example, at least, by weight, 1%, 5%, 10%, 25%, 50%, 75%, or 100% broth. The amount of biomass in the product, by weight, may be, for example, anywhere from 0% to 100% inclusive of all percentages therebetween.

In some embodiments, the biosurfactant is utilized after being extracted from a fermentation broth and, optionally, purified.

The biosurfactant according to the subject invention can be a glycolipid (e.g., sophorolipids, rhamnolipids, cellobiose lipids, mannosylerythritol lipids and trehalose lipids), lipopeptide (e.g., surfactin, iturin, fengycin, arthrofactin and lichenysin), flavolipid, phospholipid (e.g., cardiolipins), fatty acid ester compound, fatty acid ether compound, and/or high molecular weight polymers such as lipoproteins, lipopolysaccharide-protein complexes, and polysaccharide-protein-fatty acid complexes.

In certain specific embodiments, the biosurfactant is a sophorolipid (SLP), including linear SLP, lactonic SLP, acetylated SLP, de-acetylated SLP, salt-form SLP derivatives, esterified SLP derivatives, amino acid-SLP conjugates, and other SLP derivatives or isomers that exist in nature and/or are produced synthetically. In preferred embodiments, the SLP is a linear SLP or a derivatized linear SLP.

In certain embodiments, the subject compositions can comprise lactonic and linear SLP, with at least about 50%, about 55%, about 60%, about 65%, about 70%, about 75%, about 80%, about 85%, about 90%, or about 95% of the SLP comprising linear forms, and the remainder comprising lactonic forms.

In some embodiments, the biosurfactant can be included in the composition at 0.001 to 99.9%, 0.1 to 90%, 0.5 to 80%, 0.75 to 70%, 1.0 to 50%, 1.5 to 25%, or 2.0 to 15% by weight, with respect to the total granulation aid composition.

In another embodiment, a purified biosurfactant may be added in combination with an acceptable carrier, in that the biosurfactant may be presented at concentrations of 0.001 to 50% (v/v), preferably, 0.01 to 20% (v/v), more preferably, 0.02 to 5% (v/v).

In some embodiments, the biosurfactant can be included in the composition at, for example, 0.01 to 100,000 ppm, 0.05 to 10,000 ppm, 0.1 to 1,000 ppm, 0.5 to 750 ppm, 1.0 to 500 ppm, 2.0 to 250 ppm, or 3.0 to 100 ppm, with respect to the amount of liquid being treated.

In certain embodiments, the chemical surfactant of the granulation aid composition is a detergent, wetting agent, emulsifier, foaming agent, and/or dispersant. In some embodiments, the chemical surfactant can be included in the composition at 0.01 to 99.9%, 0.1 to 90%, 0.5 to 80%, 0.75 to 70%, 1.0 to 50%, 1.5 to 25%, or 2.0 to 15% by weight, with respect to the total granulation composition.

The granulation aid composition can further comprise other additives such as, for example, carriers, other microbe-based compositions, additional biosurfactants, enzymes, catalysts, solvents, salts, buffers, chelating agents, organic acids with more than one coordination group (e.g., rubeanic acid), STPP (sodiumtripolyphosphate, Na5P3O10), trisodium phosphate (TSP) or any combination thereof), acids, emulsifying agents, lubricants, solubility controlling agents, preservatives, stabilizers, ultra-violet light resistant agents, viscosity modifiers, preservatives, tracking agents, glycols, phenols, ketones, hydrocarbons, and other microbes and other ingredients specific for an intended use.

In certain embodiments, chelating agents can be, but are not limited to, ethylenediaminetetraacetic acid (EDTA), nitrilotriacetic acid (NTA), nitrilotris(methylene)triphosphonic acid (NTTA), trimethylenedinitrilotetraacetic acid (TMDTA), L-5-glutamyl-L-cysteinylglycine (GCG), calcium trisodium diethylenetriaminepentaacetic acid, sodium nitrilotriacetic acid, a phosphonate, succimer (DMSA), diethylenetriaminepentaacetate (DTPA), N-acetylcysteine, n-hydroxyethylethylenediaminetriacetic acid (HEDTA), organic acids with more than one coordination group (e.g., rubeanic acid), STPP (sodiumtripolyphosphate, Na₅P₃O₁₀), trisodium phosphate (TSP), water, carbohydrates, organic acids with more than one coordination group (e.g., citric acid), lipids, steroids, amino acids or related compounds (e.g., glutathione), peptides, phosphates, nucleotides, tetrapyrroles, ferrioxamines, ionophores, orphenolics, sodium citrate, sodium gluconate, ethylenediamine disuccinic acid (EDDS), iminodisuccinic acid (IDS), L-glutamic acid N,N diacetic acid (GLDA), GLDA-Na4, methyl glycinediacetic acid (MGDA), polyaspartic acid (PASA), hemoglobin, chlorophyll, lipophilic β-diketone, and (14,16)-hentriacontanedione, ethylenediamine-N,N′-diglutaric acid (EDDG), ethylenediamine-N,N′-dimalonic acid (EDDM), 3-hydroxy-2,2-iminodisuccinic acid (HIDS), 2-hydroxyethyliminodiacetic acid (HEIDA), pyridine-2,6-dicarboxylic acid (PDA), trimethyl glycine (TMG), Tiron, or any combination thereof.

### Methods of Granulation

In certain embodiments, the subject invention provides a method for the granulation of particles from various sources, including, for example, mining sites, quarrying sites, and industrial sites.

In certain embodiments, the composition can be used during wet or dry granulation to increase the size of particles. In certain embodiments, dry granulation can be used with moisture or heat-reactive ingredients in the granulation process, in which a granulation aid composition is added to the ingredients. In certain embodiments, wet granulation can be used in which a liquid with dissolved or suspended functional excipients, usually a polymer or binder, is sprayed on a target. In certain embodiments, the subject biosurfactants can replace or be used in conjunction with existing compounds used for granulation. In certain embodiments, when the granulation process runs under wetter conditions, lower temperature and higher spray rates, the target particles stick together, agglomerate, and form the granulate at a higher rather than if the process runs too dry, in which the granulate can fall apart.

In certain embodiments, the composition can be used during the fluid bed granulation process, which involves suspending particles in an air stream and spraying a liquid containing the subject composition from the top of the system down onto the fluidized bed or the bottom of the system up onto the fluidized bed.

In certain embodiments, the particles and granulation aid composition is compressed by force, using, for example, roller compactors or a centrifuge. The resulting sheet is then broken into flakes, and these in turn can be further broken into granules.

The compositions can be applied to liquids or solids that reside at a range of temperatures and environments, such as, for example, a containment pond, holding tank, belt, tubing, piping, tumbler, silo, roller, compacter, auger, hopper, agitator, granulator, furnace, screw, impeller, or drum.

The granulation aid composition can be applied to a liquid or solid and, optionally, mixed by adding, pouring, or combining.

In certain embodiments, the time period in which the granulation aid composition can be contacted to a liquid or solid is for about 1 second to about 1 year, about 1 minute to about 1 year, about 1 minute to about 6 months, about 1 minute to about 1 month, about 1 minute to about 1 week, about 1 minute to about 48 hours, about 30 minutes to 40 hours, or preferably about 12 hours to 24 hours. In certain embodiments, the methods comprise applying a liquid or solid form of the granulation aid composition to the liquid containing particles for the period of time in which liquid containing particles are being aggregated or until the size of particles has been increased to an amount that is determined to be satisfactory, which can be readily determined by one skilled in the art. In certain embodiments, the methods comprise applying a liquid or solid form of the granulation aid composition to the solid for the period of time in which the solid is being aggregated or until the size of particles has been increased to an amount that is determined to be satisfactory, which can be readily determined by one skilled in the art. The size of the particles may be considered acceptable depending on the context. For example, the size of particles may be acceptable at a larger diameter during the production of pharmaceutical tablets than during the production of fertilizer granules.

In certain embodiments, the amount of the granulation aid composition applied is about 0.00001 to 15%, about 0.00001 to 10%, about 0.0001 to 5%, about 0.001 to 3%, or 0.02% to about 0.08 vol % based on an amount of liquid that is treated. In certain embodiments, the amount of the granulation aid composition applied is about 0.00001 to 15%, about 0.00001 to 10%, about 0.0001 to 5%, about 0.001 to 3%, or about 0.02% to about 0.08 weight % based on an amount of solid that is treated.

In certain embodiments, the methods of the subject invention result in at least a 25% increase in the rate of the granulation of solids or liquids containing solids, preferably at least a 50% increase, after one treatment. In certain embodiments, the solid or liquid containing solids can be treated multiple times to further increase the total amount of aggregated particles and/or further increase the rate of granulation.

In certain embodiments, the granulation aid composition according to the subject invention is effective due to increasing the wettability and/or increasing aggregation of particles. For example, in some embodiments, a sophorolipid will form a micelle containing and/or linking the particles, wherein the micelle is less than 500 μm, less than 100 μm, less than 10 μm, less than 1 μm, less than 100 nm, less than 50 nm, less than 25 nm, less than 15 nm or less than 10 nm in size. The small size and amphiphilic properties of the micelle allow for enhanced penetration into the particles, allowing for enhanced wettability or aggregation of particles. In certain embodiments, the addition of a granulation aid to particles can assist in the creation of a homogenous granule.

In certain embodiments, the granulation aid compositions can be used in methods of processing ores, ore slurries, minerals, compounds, elements, or other products obtained via mining or quarrying. In certain embodiments, the mining site can be a coal mine, iron ore mine (e.g., taconite), copper mine, copper-nickel mine, tin mine, nickel mine, gold mine, silver mine, molybdenum mine, aluminum mine (e.g., bauxite mine, kyanite mine), lead-zinc mine, tungsten mine, zirconium mine (e.g., zircon), potash mine, or zinc mine. The mine can be an underground mine, surface mine, placer mine or in situ mine. In certain embodiments, the quarrying site can extract chalk, clay, cinder, coal, sand, gravel, coquina, diabase, gabbro, granite, gritstone, gypsum, limestone, marble, ores, phosphate rock, quartz, sandstone, slate, travertine, or any combination thereof.

In certain embodiments, the granulation aid composition can be used to make ore fines, fluxes, fuels, and dusts or plastics into granules. The granulation process comprises particle size enlargement implemented by the layering of fine particles that adhere onto the coarser nucleus particles. In certain embodiments, the resulting granules can be used in sintering processes of various substances, including, for example, metals (e.g., iron, tungsten, molybdenum), ceramics (e.g., glass, alumina, zirconia, silica, magnesia, lime, beryllium oxide, and ferric oxide), and plastics (e.g., polyethylene).

In certain embodiments, the granulation aid compositions can be used in methods of creating fertilizers. In certain embodiments, raw materials used to produce fertilizers can be mined and/or synthesized. In certain embodiments, mined components include, for example, potash, copper, molybdenum, phosphate rock, sylvite, carnallite, and sodium nitrate. Synthesized components include, for example, ammonium nitrate and ammonium phosphate. In certain embodiments, each of the different components of the fertilizer are granulated using the subject compositions, by, for example, applying the subject compositions to the fertilizer components and adding the mixture to a rotating drum. As the drum rotates, pieces of the solid fertilizer components take on small spherical shape and can pass through a screen that separates out adequately sized particles.

In certain embodiments, the granulation aid compositions can be used in methods of creating pesticide or herbicide granules. In certain embodiments, the pesticide or herbicide granules can comprise mined components, including, for example, clay or talc, that can be used as a carrier for the active compound, such as, for example, permethrin. In certain embodiments, the subject compositions can be used to facilitate the adhesion of the carrier particles to each other and/or to the active compound(s). The granules can be in a ready-to-use formulation or a concentrated formulation. The active ingredient either coats the outside of the granules or is absorbed into small particles of clay, talc, or similar carrier.

In certain embodiments, the granulation aid compositions can be used in methods of creating pharmaceutical, cosmetics, food products, or dietary supplements, particularly in the initial steps of creating a tablet. In certain embodiments, the active pharmaceutical ingredient (API), cosmetic compound, food (e.g., animal feed, food powder), or supplement (e.g., vitamin) is mixed with the subject compositions until a homogeneous mixture of granules is achieved. In preferred embodiments, an impeller rotates at slow speeds, spinning powders (e.g., API, cosmetic, food powder, vitamin) into a vortex. After the powders are blended together, the subject composition containing a biosurfactant is added to the powders using a pump, sprayer, or pressurized container and the mixing continues until the desired granule size and density are achieved. In certain embodiments, the granules can then be compressed.

Advantageously, in certain embodiments, the granulation aid composition according to the subject invention provides enhanced or increased granulation efficiency with limited negative environmental impacts. Additionally, the methods of the subject invention do not require complicated equipment or high energy consumption, and the production of the granulation aid composition can be performed on site, including, for example, at a mine or at an industrial site. In certain embodiments, the subject granulation aid composition can result in a decreased use of chemical surfactants, synthetic granulation aids, or other potentially harmful chemicals used for granulation.

### Production of Microbe-Based Products

In certain embodiments, the subject invention provides methods for cultivation of microorganisms and production of microbial metabolites and/or other by-products of microbial growth. The subject invention further utilizes cultivation processes that are suitable for cultivation of microorganisms and production of microbial metabolites on a desired scale. These cultivation processes include, but are not limited to, submerged cultivation/fermentation, solid state fermentation (SSF), and modifications, hybrids and/or combinations thereof.

The microorganisms can be, for example, bacteria, yeast and/or fungi. These microorganisms may be natural, or genetically modified microorganisms. For example, the microorganisms may be transformed with specific genes to exhibit specific characteristics. The microorganisms may also be mutants of a desired strain. As used herein, “mutant” means a strain, genetic variant or subtype of a reference microorganism, wherein the mutant has one or more genetic variations (e.g., a point mutation, missense mutation, nonsense mutation, deletion, duplication, frameshift mutation or repeat expansion) as compared to the reference microorganism. Procedures for making mutants are well known in the microbiological art. For example, UV mutagenesis and nitrosoguanidine are used extensively toward this end.

In certain embodiments, the microbes are capable of producing amphiphilic molecules, enzymes, proteins and/or biopolymers. Microbial biosurfactants, in particular, are produced by a variety of microorganisms such as bacteria, fungi, and yeasts, including, for example, Agrobacterium spp. (e.g., A. radiobacter); Arthrobacter spp.; Aspergillus spp.; Aureobasidium spp. (e.g., A. pullulans); Azotobacter (e.g., A. vinelandii, A. chroococcum); Azospirillum spp. (e.g., A. brasiliensis); Bacillus spp. (e.g., B. subtilis, B. amyloliquefaciens, B. pumillus, B. cereus, B. licheniformis, B. firmus, B. laterosporus, B. megaterium); Blakeslea; Candida spp. (e.g., C. albicans, C. rugosa, C. tropicalis, C. lipolytica, C. torulopsis); Clostridium (e.g., C. butyricum, C. tyrobutyricum, C. acetobutyricum, and C. bejerinckii); Campylobacter spp.; Cornybacterium spp.; Cryptococcus spp.; Debaryomyces spp. (e.g., D. hansenii); Entomophthora spp.; Flavobacterium spp.; Gordonia spp.; Hansenula spp.; Hanseniaspora spp. (e.g., H. uvarum); Issatchenkia spp; Kluyveromyces spp.; Meyerozyma spp. (e.g., M. guilliermondii); Mortierella spp.; Mycorrhiza spp.; Mycobacterium spp.; Nocardia spp.; Pichia spp. (e.g., P. anomala, P. guilliermondii, P. occidentalis, P. kudriavzevii); Phycomyces spp.; Phythium spp.; Pseudomonas spp. (e.g., P. aeruginosa, P. chlororaphis, P. putida, P. florescens, P. fragi, P. syringae); Pseudozyma spp. (e.g., P. aphidis); Ralslonia spp. (e.g., R. eulropha); Rhodococcus spp. (e.g., R. erythropolis); Rhodospirillum spp. (e.g., R. rubrum); Rhizobium spp.; Rhizopus spp.; Saccharomyces spp. (e.g., S. cerevisiae, S. boulardii sequela, S. torula); Sphingomonas spp. (e.g., S. paucimobilis); Starmerella spp. (e.g., S. bombicola); Thraustochytrium spp.; Torulopsis spp.; Ustilago spp. (e.g., U. maydis); Wickerhamomyces spp. (e.g., W. anomalus); Williopsis spp.; and/or Zygosaccharomyces spp. (e.g., Z. bailii).

In preferred embodiments, microorganism is a Starmerella spp. yeast and/or Candida spp. yeast, e.g., Starmerella (Candida) bombicola, Candida apicola, Candida batistae, Candida floricola, Candida riodocensis, Candida stellate and/or Candida kuoi. In a specific embodiment, the microorganism is Starmerella bombicola, e.g., strain ATCC 22214.

As used herein “fermentation” refers to cultivation or growth of cells under controlled conditions. The growth could be aerobic or anaerobic. In preferred embodiments, the microorganisms are grown using SSF and/or modified versions thereof.

In one embodiment, the subject invention provides materials and methods for the production of biomass (e.g., viable cellular material), extracellular metabolites (e.g., small molecules and excreted proteins), residual nutrients and/or intracellular components (e.g., enzymes and other proteins).

The microbe growth vessel used according to the subject invention can be any fermenter or cultivation reactor for industrial use. In one embodiment, the vessel may have functional controls/sensors or may be connected to functional controls/sensors to measure important factors in the cultivation process, such as pH, oxygen, pressure, temperature, humidity, microbial density and/or metabolite concentration.

In a further embodiment, the vessel may also be able to monitor the growth of microorganisms inside the vessel (e.g., measurement of cell number and growth phases). Alternatively, a daily sample may be taken from the vessel and subjected to enumeration by techniques known in the art, such as dilution plating technique. Dilution plating is a simple technique used to estimate the number of organisms in a sample. The technique can also provide an index by which different environments or treatments can be compared.

In one embodiment, the method includes supplementing the cultivation with a nitrogen source. The nitrogen source can be, for example, potassium nitrate, ammonium nitrate ammonium sulfate, ammonium phosphate, ammonia, urea, and/or ammonium chloride. These nitrogen sources may be used independently or in a combination of two or more.

The method can provide oxygenation to the growing culture. One embodiment utilizes slow motion of air to remove low-oxygen containing air and introduce oxygenated air. In the case of submerged fermentation, the oxygenated air may be ambient air supplemented daily through mechanisms including impellers for mechanical agitation of liquid, and air spargers for supplying bubbles of gas to liquid for dissolution of oxygen into the liquid.

The method can further comprise supplementing the cultivation with a carbon source. The carbon source is typically a carbohydrate, such as glucose, sucrose, lactose, fructose, trehalose, mannose, mannitol, and/or maltose; organic acids such as acetic acid, fumaric acid, citric acid, propionic acid, malic acid, malonic acid, and/or pyruvic acid; alcohols such as ethanol, propanol, butanol, pentanol, hexanol, isobutanol, and/or glycerol; fats and oils such as soybean oil, canola oil, rice bran oil, olive oil, corn oil, sesame oil, and/or linseed oil; etc. These carbon sources may be used independently or in a combination of two or more.

In one embodiment, growth factors and trace nutrients for microorganisms are included in the medium. This is particularly preferred when growing microbes that are incapable of producing all of the vitamins they require. Inorganic nutrients, including trace elements such as iron, zinc, copper, manganese, molybdenum and/or cobalt may also be included in the medium. Furthermore, sources of vitamins, essential amino acids, and microelements can be included, for example, in the form of flours or meals, such as corn flour, or in the form of extracts, such as yeast extract, potato extract, beef extract, soybean extract, banana peel extract, and the like, or in purified forms. Amino acids such as, for example, those useful for biosynthesis of proteins, can also be included.

In one embodiment, inorganic salts may also be included. Usable inorganic salts can be potassium dihydrogen phosphate, dipotassium hydrogen phosphate, disodium hydrogen phosphate, magnesium sulfate, magnesium chloride, iron sulfate, iron chloride, manganese sulfate, manganese chloride, zinc sulfate, lead chloride, copper sulfate, calcium chloride, sodium chloride, calcium carbonate, and/or sodium carbonate. These inorganic salts may be used independently or in a combination of two or more.

In some embodiments, the method for cultivation may further comprise adding additional acids and/or antimicrobials in the medium before, and/or during the cultivation process. Antimicrobial agents or antibiotics are used for protecting the culture against contamination.

Additionally, antifoaming agents may also be added to prevent the formation and/or accumulation of foam during submerged cultivation.

The pH of the mixture should be suitable for the microorganism of interest. Buffers, and pH regulators, such as carbonates and phosphates, may be used to stabilize pH near a preferred value. When metal ions are present in high concentrations, use of a chelating agent in the medium may be necessary.

The microbes can be grown in planktonic form or as biofilm. In the case of biofilm, the vessel may have within it a substrate upon which the microbes can be grown in a biofilm state. The system may also have, for example, the capacity to apply stimuli (such as shear stress) that encourages and/or improves the biofilm growth characteristics.

In one embodiment, the method for cultivation of microorganisms is carried out at about 5° to about 100° C., preferably, 15 to 60° C., more preferably, 25 to 50° C. In a further embodiment, the cultivation may be carried out continuously at a constant temperature. In another embodiment, the cultivation may be subject to changing temperatures.

In one embodiment, the equipment used in the method and cultivation process is sterile. The cultivation equipment such as the reactor/vessel may be separated from, but connected to, a sterilizing unit, e.g., an autoclave. The cultivation equipment may also have a sterilizing unit that sterilizes in situ before starting the inoculation. Air can be sterilized by methods know in the art. For example, the ambient air can pass through at least one filter before being introduced into the vessel. In other embodiments, the medium may be pasteurized or, optionally, no heat at all added, where the use of low water activity and low pH may be exploited to control undesirable bacterial growth.

In one embodiment, the subject invention further provides a method for producing microbial metabolites such as, for example, biosurfactants, enzymes, proteins, ethanol, lactic acid, beta-glucan, peptides, metabolic intermediates, polyunsaturated fatty acid, and lipids, by cultivating a microbe strain of the subject invention under conditions appropriate for growth and metabolite production; and, optionally, purifying the metabolite. The metabolite content produced by the method can be, for example, at least 20%, 30%, 40%, 50%, 60%, 70%, 80%, or 90%.

The microbial growth by-product produced by microorganisms of interest may be retained in the microorganisms or secreted into the growth medium. The medium may contain compounds that stabilize the activity of microbial growth by-product.

The biomass content of the fermentation medium may be, for example, from 5 g/l to 180 g/l or more, or from 10 g/l to 150 g/l.

The cell concentration may be, for example, at least 1×10⁶ to 1×10¹², 1×10⁷ to 1×10¹¹, 1×10⁸ to 1×10¹⁰, or 1×10⁹ CFU/ml.

The method and equipment for cultivation of microorganisms and production of the microbial by-products can be performed in a batch, a quasi-continuous process, or a continuous process.

In one embodiment, all of the microbial cultivation composition is removed upon the completion of the cultivation (e.g., upon, for example, achieving a desired cell density, or density of a specified metabolite). In this batch procedure, an entirely new batch is initiated upon harvesting of the first batch.

In another embodiment, only a portion of the fermentation product is removed at any one time. In this embodiment, biomass with viable cells, spores, conidia, hyphae and/or mycelia remains in the vessel as an inoculant for a new cultivation batch. The composition that is removed can be a cell-free medium or contain cells, spores, or other reproductive propagules, and/or a combination of thereof. In this manner, a quasi-continuous system is created.

Advantageously, the method does not require complicated equipment or high energy consumption. The microorganisms of interest can be cultivated at small or large scale on site and utilized, even being still-mixed with their media.

In certain embodiments, the subject invention provides a “microbe-based composition,” meaning a composition that comprises components that were produced as the result of the growth of microorganisms or other cell cultures. Thus, the microbe-based composition may comprise the microbes themselves and/or by-products of microbial growth. The microbes may be in a vegetative state, in spore form, in mycelial form, in any other form of propagule, or a mixture of these. The microbes may be planktonic or in a biofilm form, or a mixture of both. The by-products of growth may be, for example, metabolites, cell membrane components, expressed proteins, and/or other cellular components. The microbes may be intact or lysed. The microbes may be present in or removed from the composition. The microbes can be present, with broth in which they were grown, in the microbe-based composition. The cells may be present at, for example, a concentration of at least 1×10³, 1×10⁴, 1×10⁵, 1×10⁶, 1×10⁷, 1×10⁸, 1×10⁹, 1×10¹⁰, 1×10¹¹, 1×10¹², 1×10¹³ or more CFU per milliliter of the composition.

The subject invention further provides “microbe-based products,” which are products that are to be applied in practice to achieve a desired result. The microbe-based product can be simply a microbe-based composition harvested from the microbe cultivation process. Alternatively, the microbe-based product may comprise further ingredients that have been added. These additional ingredients can include, for example, stabilizers, acids, buffers, carriers, such as water, salt solutions, or any other appropriate carrier, added nutrients to support further microbial growth, non-nutrient growth enhancers, and/or agents that facilitate tracking of the microbes and/or the composition in the environment to which it is applied. The microbe-based product may also comprise mixtures of microbe-based compositions. The microbe-based product may also comprise one or more components of a microbe-based composition that have been processed in some way such as, but not limited to, filtering, centrifugation, lysing, drying, purification and the like.

One microbe-based product of the subject invention is simply the fermentation medium containing the microorganisms and/or the microbial metabolites produced by the microorganisms and/or any residual nutrients. The product of fermentation may be used directly without extraction or purification. If desired, extraction and purification can be easily achieved using standard extraction and/or purification methods or techniques described in the literature.

The microorganisms in the microbe-based products may be in an active or inactive form, or in the form of vegetative cells, reproductive spores, conidia, mycelia, hyphae, or any other form of microbial propagule. The microbe-based products may also contain a combination of any of these forms of a microorganism.

In one embodiment, different strains of microbe are grown separately and then mixed together to produce the microbe-based product. The microbes can, optionally, be blended with the medium in which they are grown and dried prior to mixing.

The microbe-based products may be used without further stabilization, preservation, and storage. Advantageously, direct usage of these microbe-based products preserves a high viability of the microorganisms, reduces the possibility of contamination from foreign agents and undesirable microorganisms, and maintains the activity of the by-products of microbial growth.

Upon harvesting the microbe-based composition from the growth vessels, further components can be added as the harvested product is placed into containers or otherwise transported for use. The additives can be, for example, buffers, carriers, other microbe-based compositions produced at the same or different facility, viscosity modifiers, preservatives, nutrients for microbe growth, surfactants, emulsifying agents, lubricants, solubility controlling agents, tracking agents, solvents, biocides, antibiotics, pH adjusting agents, chelators, stabilizers, ultra-violet light resistant agents, other microbes and other suitable additives that are customarily used for such preparations.

Optionally, the product can be stored prior to use. The storage time is preferably short. Thus, the storage time may be less than 60 days, 45 days, 30 days, 20 days, 15 days, 10 days, 7 days, 5 days, 3 days, 2 days, 1 day, or 12 hours. In a preferred embodiment, if live cells are present in the product, the product is stored at a cool temperature such as, for example, less than 20° C., 150 C, 10° C., or 5° C. On the other hand, a biosurfactant composition can typically be stored at ambient temperatures.

1. A method of granulation, the method comprising applying a granulation aid composition comprising a biosurfactant to a liquid containing particles or to solid particles to yield a granule,
wherein the particles in the liquid or the solid particles comprise chalk, clay, cinder, coal, sand, gravel, coquina, diabase, gabbro, granite, gritstone, gypsum, limestone, marble, ores, phosphate rock, quartz, sandstone, slate, travertine, or any combination thereof.

2. The method of claim 1, further comprising mixing the granulation aid composition comprising a biosurfactant and the liquid containing particles or the solid particles.

3. The method of claim 1, further comprising removing said granule from the liquid or drying the granule.

4. The method of claim 1, wherein the particles in the liquid or the solid particles comprise a metal ore, mineral, or element.

5. The method of claim 4, wherein the metal ore is from an iron ore mine, copper mine, copper-nickel mine, molybdenum mine, or tungsten mine, or
wherein the mineral is from a potash mine, sylvite mine, phosphate mine, clay mine, talc mine, or carnallite mine.

6. (canceled)

7. (canceled)

8. The method of claim 1, wherein the granulation aid composition further comprises a chemical surfactant, polymer, water, binder, solvent, or any combination thereof.

9. (canceled)

10. The method of claim 1, wherein the granulation aid composition is in liquid form, and wherein the contacting step comprises mixing the granulation aid composition with the liquid containing particles for a time period of about 1 second to about 1 year.

11. The method of claim 1, wherein the granulation aid composition is in a solid form, and wherein the contacting step comprises mixing the granulation aid composition with the solid particles for a time period of about 1 second to about 1 year.

12. The method of claim 1, wherein the concentration of the granulation aid composition contacted to the solid is about 0.001% to about 10% by weight or to the liquid is about 0.0010% to about 10% by volume.

13. The method of claim 1, wherein the biosurfactant is a glycolipid and/or an inactive yeast culture comprising a glycolipid.

14. The method of claim 13, wherein the inactive yeast culture is a Starmerella sp. and/or a Candida sp. yeast.

15. The method of claim 13, wherein the glycolipid is a sophorolipid, mannosylerythritol lipid, trehalose lipid, rhamnolipid, or any combination thereof.

16. The method of claim 15, wherein the sophorolipid is a linear sophorolipid or a lactonic sophorolipid.

17. The method of claim 1, wherein the granulation of particles comprises one or a combination of the following: a) adhering particles to a surface and/or object; b) agglomerating particles; c) increasing wettability of particles; or d) homogenizing the particles within the granule.

18. A granulation aid composition comprising a biosurfactant and/or an inactive yeast culture comprising a biosurfactant and one or more traditional granulation aid components.

19. The composition of claim 18, wherein the inactive yeast culture is a Starmerella sp. and/or a Candida sp. yeast.

20. The composition of claim 18, wherein the glycolipid is a sophorolipid, mannosylerythritol lipid, trehalose lipid, rhamnolipid, or any combination thereof.

21. The composition of claim 20, wherein the sophorolipid is a linear sophorolipid or a lactonic sophorolipid.

22. The composition of claim 18, wherein the traditional granulation aid components are selected from one or a combination of the following: a) chemical surfactant; b) polymer; c) water; d) binder; or e) solvent.

23. The composition of claim 22, wherein the solvent is an alcohol.
